(19) United States
(12) Patent Application Publication
(10) Pub. No.: US 2008/0062900 A1
(43) Pub. Date: Mar. 13, 2008

(54) Device and Network Capable of Mobile Device Management

(76) Inventor: Bindu Rama Rao, Laguna Niguel, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/854,414

(22) Filed: Sep. 12, 2007

Related U.S. Application Data
(60) Provisional application No. 60/844,156, filed on Sep. 12, 2006.

(51) Int. Cl. H04B 7/00

(52) U.S. Cl. 370/310

(57) ABSTRACT

A method and system for interfacing to an electronic device is disclosed. At least one server may be used to manage an electronic device over a wireless metropolitan area network. Accordingly, the electronic device, which may be a mobile device, may be activated over-the-air. The electronic device may be minimally provisioned to allow initiation of the activation process. As part of activation, the servers can provision the electronic device and download applications that the electronic device needs for services that a user of the electronic device subscribed to. The services can then be enabled on the electronic device.

The present application makes reference to, claims priority to, and claims benefit of U.S. Provisional Application Ser. No. 60/844,156 entitled “Device And WiMax Network Capable Of Mobile Device Management,” filed Sep. 12, 2006, the complete subject matter of which is hereby incorporated herein by reference, in its entirety.

The Applicant hereby identifies the following patent applications pursuant to 37 C.F.R. §1.78(f)(1):

U.S. patent application Ser. No. 11/839,143 (Attorney Docket No. 17778US02) filed Aug. 15, 2007;
PCT Application No. PCT/U.S.07/76001 (Attorney Docket No. 17778WO01) filed Aug. 15, 2007;
U.S. patent application Ser. No. 11/847,658 (Attorney Docket No. 18154US02) filed on Aug. 30, 2007; and
PCT Application No. PCT/U.S.07/77288 (Attorney Docket No. 18154WO01) filed Aug. 30, 2007.

### BACKGROUND OF THE INVENTION

Electronic devices, such as mobile phones and personal digital assistants (PDA's), often contain firmware and application software that are either provided by the manufacturers of the electronic devices, by telecommunication carriers, or by third parties. When a user starts his subscription with a service provider, various service options may need to be configured for the electronic device in accordance with the user's service plan. Accordingly, various parameters may need to be set or changed in an electronic device before a user is able to use his electronic device properly. However, different electronic devices may have different set of resources, different sets of parameters, etc., and managing the wide variety of mobile devices in a heterogeneous network may be a problem.

Further limitations and disadvantages of conventional and traditional approaches will become apparent to one of skill in the art, through comparison of such systems with the present invention as set forth in the remainder of the present application with reference to the drawings.

### BRIEF DESCRIPTION OF SEVERAL VIEWS OF THE DRAWINGS

FIG. 1A is a perspective block diagram of a network that is capable of provisioning and managing WiMax based electronic devices, in accordance with an embodiment of the present invention.

FIG. 1B is a perspective block diagram of an exemplary electronic device that supports device management, in accordance with an embodiment of the present invention.

FIG. 2 is a diagram of an exemplary management object for quality of service classes, in accordance with an embodiment of the present invention.

FIG. 3 is a diagram of an exemplary management object for connectivity parameters, in accordance with an embodiment of the present invention.

FIG. 4 is a flowchart of an exemplary method for personalizing an electronic device, in accordance with an embodiment of the present invention.

FIG. 5 is a flowchart of an exemplary method for device side support for activation, in accordance with an embodiment of the present invention.

FIG. 6 is an exemplary menu for self-care by a user, in accordance with an embodiment of the present invention.

### DETAILED DESCRIPTION OF THE INVENTION

Aspects of the present invention relates generally to an interface between an electronic device and a network, and, more specifically, to a device and network capable of mobile device management. While the following discussion focuses primarily on mobile electronic devices such as, for example, a mobile handset, a cellular phone, a personal digital assistant, a pager, and a handheld personal computer, this is by way of example and not by way of specific limitations of the present invention. The teachings contained herein may also be applicable to a variety of other electronic devices for which a device and network capable of mobile device management may be desirable.

Various embodiments of the present invention may comprise interfacing to electronic devices using wired or wireless communication channels such as, for example, a public switched telephone network, a wired local or wide area network, an intranet, the Internet, and wireless cellular, paging, local area, personal area, and various networks such as those referred to as WiFi, WiMax, Bluetooth, and similar types of communication links.

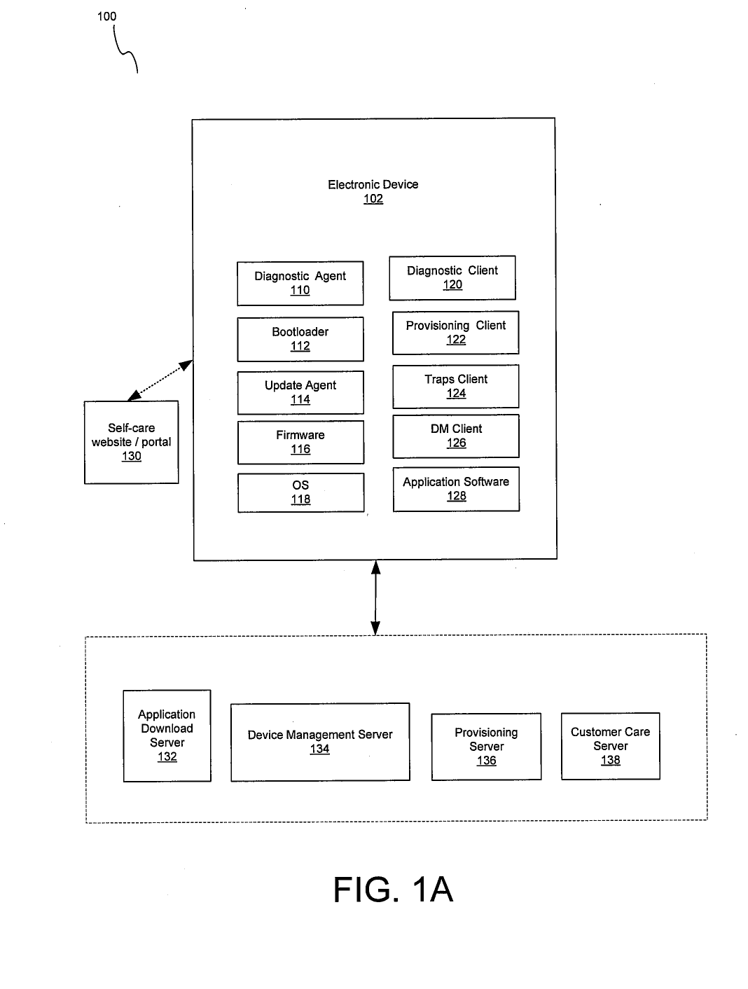

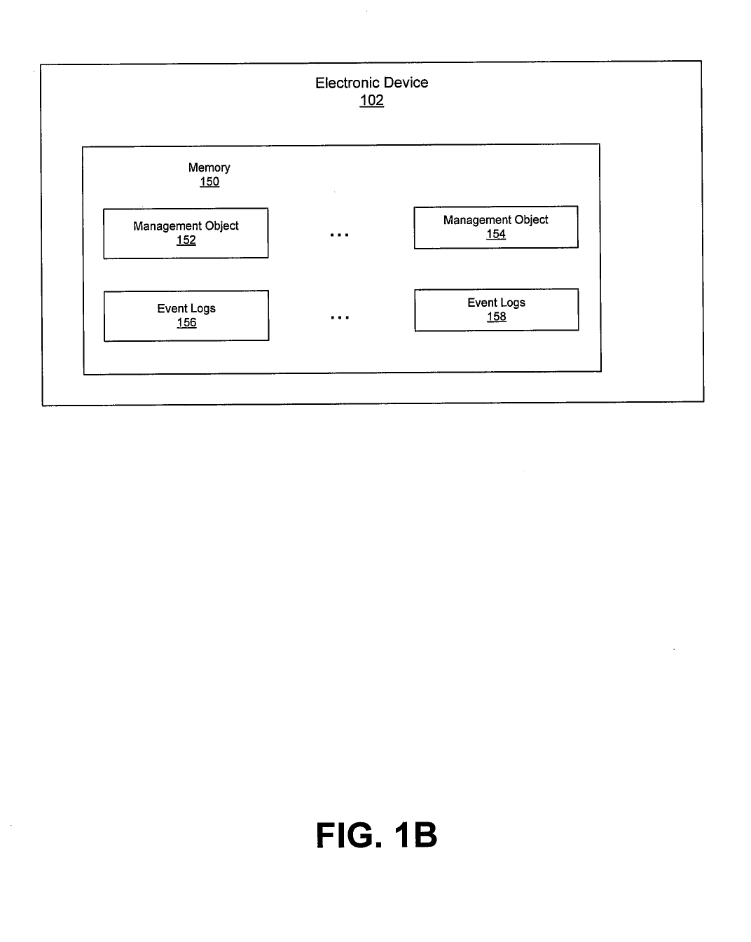

FIG. 1A is a perspective block diagram of a network that is capable of provisioning and managing WiMax based electronic devices, in accordance with an embodiment of the present invention. Referring to FIG. 1A, there is shown a network system 100 that comprises a plurality of servers 132 . . . 138, such as, for example, an application download server 132, a device management (DM) server 134, a provisioning server 136, and a customer care server 138. There is also shown an electronic device 102 that may receive personalized services via the servers 132 . . . 138. The electronic device 102 may also access a self-care website 130 where a user of the electronic device 102 may select personalized services for the electronic device 102.

The electronic device 102 may be, for example, a mobile terminal such as a cellular phone or a personal digital assistant (PDA). The electronic device 102 may comprise code that may be resident in various memory devices (not shown). The term “code” may be used herein to represent one or more of executable instructions, operand data, configuration parameters, and other information stored in the electronic device 102.

Some exemplary code that may reside in the electronic device 102 may comprise, for example, a diagnostic agent 110, a bootloader 112, an update agent 114, firmware 116, operating system 118, diagnostic client 120, provisioning client 122, traps client 124, device management client 126, and application software 128.

The diagnostic agent 110 in the electronic device 102 may be a client side diagnostics application that runs on the electronic device 102 when needed and which manages and collects tracing information. The tracing information may be communicated to a server, for example, wirelessly via a data network. The diagnostic agent 110 may also monitor one or more applications, where the monitoring may be constant or periodic. The bootloader 112 may comprise suitable code that may be executed upon power-up, or system reset, to bring the electronic device 102 to an operational state. After the initial booting of the system, for example, the operating system 118 may control operation of the electronic device 102. The update agent 114 may comprise suitable code that may allow, for example, installation and/or updating of the various codes in the electronic device 102. The firmware 116 may comprise, for example, code that may enable specific functionalities of the electronic device 102 to be executed.

The diagnostic client 120 may facilitate remote diagnosis of the electronic device 102. The diagnostic client 120 may also be downloaded and executed to collect diagnostic data from applications, etc. The provisioning client 122 may enable provisioning of the electronic device 102. Provisioning of the electronic device 102 may comprise, for example, providing information to various data structures needed by various functionalities. Some functionalities may comprise, for example, communication via a wireless network, such as a WiMax network, repairing of configuration problems, and/or configuring of software and/or hardware.

The traps client 124 may facilitate the setting of traps and retrieving of collected information. The device management (DM) client 126 may comprise code that may allow interaction with the DM server 134, the diagnostic agent 110, the diagnostic client 120, and the traps client 124, to receive DM commands from the DM server 134 and to implement them in the electronic device 102. The application software 128 may comprise code that may allow a user to access various functionalities. The application download server 132 may be employed to download and/or update applications to the electronic device 102. The application download server 132 may also be used to download new firmware/software such as, for example, the diagnostics client 120, which may then be installed and activated in the electronic device 102.

The DM server 134 may support an Open Mobile Alliance (OMA) DM protocol by which the OMA DM-based application manipulates OMA DM-capable electronic devices such as, for example, the electronic device 102. The electronic device 102 may also receive provisioning information from, for example, the provisioning server 136 that may enable repairing of configuration problems or reconfiguring software and/or hardware. The electronic device 102 may be used to request updates to software/firmware via a customer care server 138 either directly by using a browser application in the electronic device 102, or via a customer service representative (CSR). The CSR may, for example, provide service to the customer using the electronic device 102 by retrieving, as necessary, one or more diagnostic management objects (MOs) that may be stored in memory of the electronic device 102. For example, the CSR may cause update information in the form of one or more update packages to be transmitted to the electronic device 102 from a remote server. Such update packages may, for example, comprise instructions to convert or transform a first version of software/firmware to a second version of software/firmware.

A user of the electronic device 102 can access, for example, the self-care website/portal 130 to request customer care service via the customer care server 138, using the device capability information as one of the parameters provided. A customer service representative (CSR) can then provide service to the customer using the electronic device 102, after determining the device capability information that is retrieved from the electronic device 102, thereby making it unnecessary for a customer to provide such information himself to a CSR. The network system 100 is capable of supporting remote diagnostics by a CSR via the customer care server 138. It can also support a diagnostic data collection request from a DM server 134 and return the collected diagnostics data to the DM server 134 or to any other authorized server in the network system 100. The customer/subscriber of the electronic device 102 might be having problems and may need some help in diagnosing the problems—the network system 100 facilitates diagnosis by a CSR via the customer care server 138, as well as by the DM server 134.

An embodiment of the present invention may be used to provision the electronic device 102, which may, for example, comprise WiMax communication capabilities with connectivity parameters that are bearer-specific and bearer-agnostic in the operator network. The term “WiMax” may be used herein to refer to the wireless metropolitan area network communication technology also known as the Institute of Electrical and Electronics Engineers, Inc. (IEEE) 802.16 family of standards. A WIMAX bearer-specific connectivity management object (WiMax MO) may provide support for provisioning, managing and querying WiMax connectivity information, quality of service (QoS) information, etc. In addition, QoS categories can be supported by the management objects. Applications that correspond to QoS parameter mapping may also be supported.

Also, event logs comprising a single log file, a set of log files, a set of buckets, a set of log segments, etc. may be used for logging events for a plurality of categories where event data may be desired. For example, event logs may be employed to collect information for various device features where diagnosis data collection and/or tracing/debugging may be turned on in the electronic device 102. Event logs may also be used to selectively collect information on specific events that are monitored, such as, for example, device specific data being collected, network performance data, etc.

The event logs may then be retrieved from the electronic device server side in pull or push mode. Traps may refer to other management objects. For example, a Trap MO may provide a reference to one or more event logs, or to one or more interior nodes of an event log or event logs. When the associated trap fires, the corresponding logging of events and related data is conducted. The event logs may be generated, for example, by various pieces of code as they are executed.

The electronic device 102 is capable of receiving update packages from one of the servers 132 . . . 138. The electronic device 102 is capable of applying the received update packages using one or more update agents 114 that are each capable of processing update packages or subsets thereof. The electronic device 102 also comprises the DM client 126 that is capable of interacting with the provisioning client 122, the diagnostic client 120 and the traps client 124. The DM client 126 typically receives DM commands from the DM server 134 and implements them. The application download server 132 is used to download firmware and software updates. It is also used to retrieve a bundle of applications needed to update a minimal or generic electronic device 102 into a device that comprises all applications corresponding to a user's subscription level or service plan.

Provisioning of carrier-specific models of electronic devices is also supported in the network system 100. In addition, a minimal carrier-specific electronic device 102 can be provisioned to work effectively with different services in the network system 100, and also be updated with additional applications subscribed to by a user. The additional applications may be those that the electronic device 102 does not initially provide, and where the user is entitled to use those additional applications according to a user's service plan.

Accordingly, in accordance with an embodiment of the present invention, the network system 100 may provision the electronic device 102 for specific device features or applications. The network system 100 may be capable of supporting management of the electronic device 102. The network system 100 may appropriately personalize the electronic device 102 based on a subscription profile for the electronic device 102, and based on the preferences of the user/subscriber and/or information retrieved from the electronic device 102.

FIG. 1B is a perspective block diagram of an exemplary electronic device that supports device management, in accordance with an embodiment of the present invention. Referring to FIG. 1B, there is shown the electronic device 102 that comprises a memory block 150. The memory block 150 may comprise a plurality of management objects (MOs) 152 . . . 154, and a plurality of event logs 156 . . . 158.

The MOs 152 . . . 154 may be created and used for each feature domain or application that can be personalized. Each application installed in the electronic device 102 may provide one or more associated personalization MOs that gets installed, and the servers 132 . . . 138 can query or manipulate the MOs to manage the electronic device 102.

For example, some of the MOs 152 . . . 154 may comprise WiMax MOs with connectivity parameters that are bearer-specific and some that are non-bearer-specific in the operator network. The WIMAX MOs, which may comprise bearer-specific connectivity information, may provide support for provisioning, managing and querying WiMax connectivity information, quality of service (QoS) information, etc. In addition, various applications with various QoS categories can be supported by the management objects.

The event logs 156 . . . 158 may comprise, for example, a single log file, a set of log files, a set of buckets, a set of log segments, etc. Logically, the event logs 156 . . . 158 may comprise a collection of logs, for example, where a log may be allocated for each category. The event logs can be employed to collect information on various device features for which diagnosis data collection or tracing/debugging is turned on in the electronic device 102. It can also be used to selectively collect information on specific events that are monitored, device specific data being collected, network performance data, etc.

The event logs may be communicated to the server side, for example, one or more of the servers 132 . . . 138 in a pull or a push mode. Traps may also be used to generate management objects that may, for example, provide a reference to an event log (or an interior node of an event log). When a trap fires, corresponding logging of events and related data may occur. The event logs may be generated by, for example, the diagnostic agent 110, the diagnostic client 120, and/or the traps client 124.

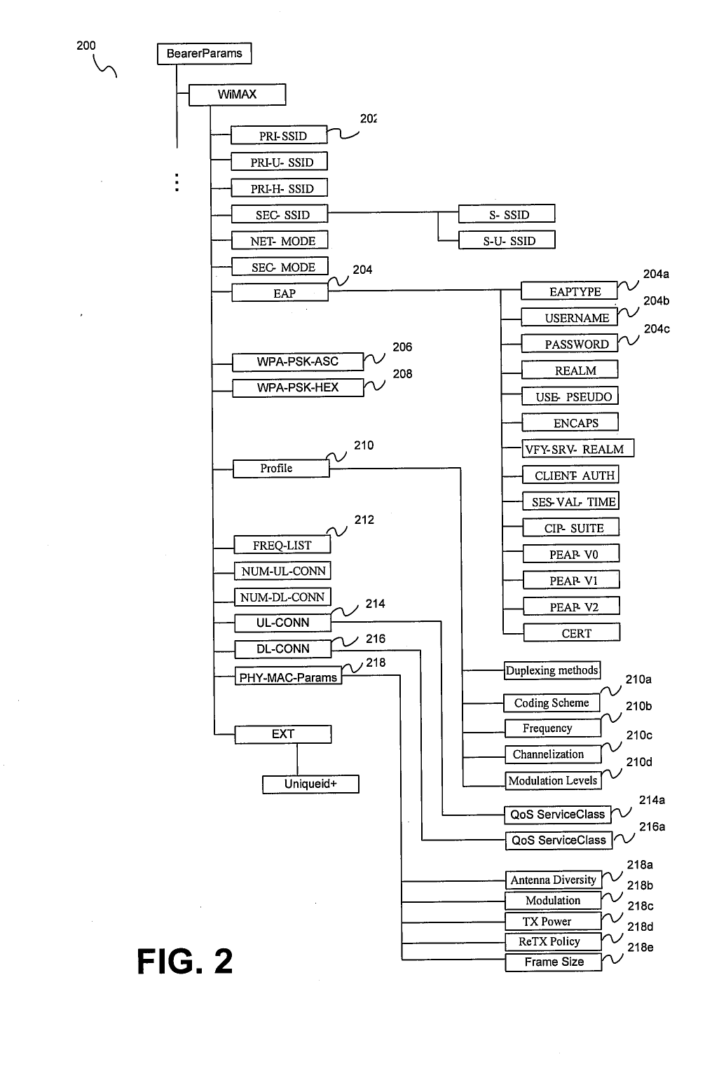

FIG. 2 is a diagram of an exemplary management object for connectivity parameters, in accordance with an embodiment of the present invention. Referring to FIG. 2, there is shown exemplary WiMax management object 200 comprising bearer connectivity parameters. Some of the parameters may be, for example, PRI-SSID field 202, EAP field 204, WPA-PSK-ASC field 206, WPA-PSK-DEC field 208, Profile field 210, FREQ_LIST field 212, UL_Conn field 214, DL_Conn field 216, and PHY_MAC field 218.

The PRI_SSID field 202 may be, for example, for a network name shared by a plurality of wireless devices on a WiMax network. The EAP field 204 may point to, for example, the EAP_TYPE field 204a, the USERNAME field 204b, and the PASSWORD field 204c, among others. The EAP_TYPE field 204a may specify, for example, which of the various extensible authentication protocol (EAP) methods that are supported by WiMax may be used in this particular network. The WPA_PSK_ASC field 206 and the WPA_PSK_DEC field 208 may be used to store, for example, a security key in ASCII and decimal format, respectively.

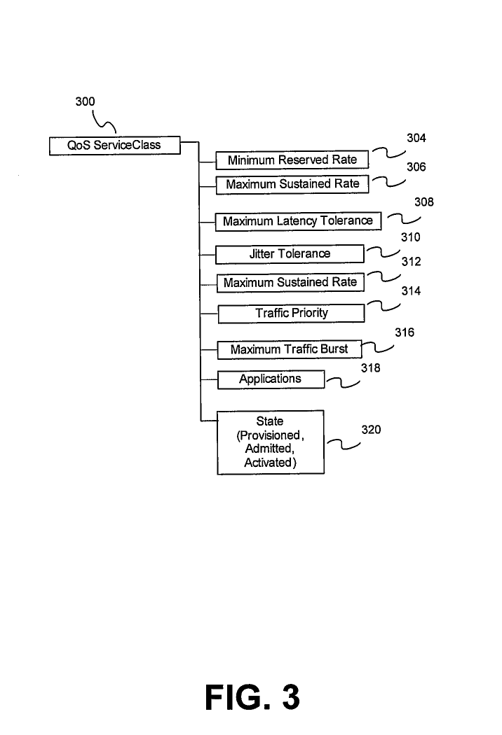

The Profile field 210 may point to, for example, the Coding_Scheme field 210a, the Frequency field 210b, the Channelization field 210c, and the Modulation_Level field 210d, among others. The FREQ_LIST field 212 may comprise, for example, a list of frequencies that may be used by the network. The UL_CONN field 214 may point to, for example, a QoS Service Class MO that may specify parameters for up-link communication. Similarly, the DL_CONN field 216 may point to, for example, a QoS Service Class MO that may specify parameters for down-link communication. The QoS Service Class MO may be described in more detail with respect to FIG. 3.

The PHY_MAC_Params field 218 may point to various parameters that may be used for Phy layer or MAC layer protocol. For example, the PHY_MAC_Params field 218 may point to an Antenna_Diversity field 218a, a Modulation field 218b, a TX_power field 218c, a ReTx_Policy field 218d, and a Frame_Size field 218e. The Antenna_Diversity field 218a may indicate, for example, whether antenna diversity may be used. The Modulation field 218b may indicate a type of modulation used, such as, for example, binary phase shift keyed (BPSK), quadrature phase shifted keyed (QPSK), quadrature amplitude modulation—16 points (QAM16), and quadrature amplitude modulation—64 points (QAM 64).

FIG. 3 is a diagram of an exemplary management object for quality of service classes, in accordance with an embodiment of the present invention. Referring to FIG. 3, there is shown a management object for a quality of service (MOQOS) class 300. The MOQOS class 300 may comprise, for example, a maximum sustained rate field 306, a maximum latency tolerance field 308, a jitter tolerance field 310, a maximum sustained rate field 312, a traffic priority field 314, a maximum traffic burst field 316, applications field 318, and state of electronic device field 320. These exemplary fields may provide information for QoS for audio streaming, video streaming, voice over Internet protocol (VoIP) calls, video surveillance, internet browsing, and other applications.

For example, a VoIP application may be assigned to an unsolicited grant services class that may use the maximum sustained rate field 306, the maximum latency tolerance field 308, and jitter tolerance field 310. Streaming audio may be assigned to real-time polling service (rtPS) class that may use the minimum reserved rate field 304, the maximum sustained rate field 306, the maximum latency tolerance field 308, and the traffic priority field 314. VoIP applications that allow voice activity detection may be assigned to an extended rtPS class that may use the minimum reserved rate field 304, the maximum sustained rate field 306, the maximum latency tolerance field 308, the jitter tolerance field 310, and the traffic priority field 314.

Other classes may be, for example, non-real-time polling service (nrtPS), which may comprise the file transfer protocol. The nrtPS may use the minimum reserved rate field 304, the maximum sustained rate field 306, and the traffic priority field 314. Web browsing may be assigned to the best-effort service class that may use the maximum sustained rate field 306, and the traffic priority field 314.

Other fields, such as, for example, the applications field 318 may indicate the applications that an electronic device may be subscribed to. The state field 320 may indicate whether the electronic device may be activated or provisioned.

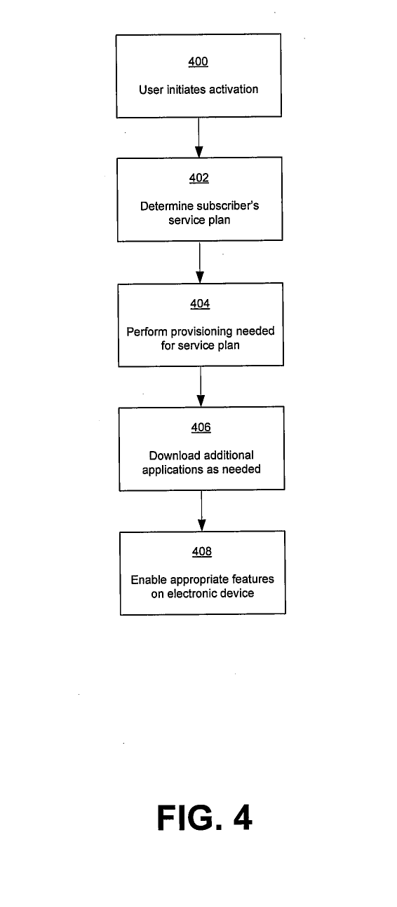

FIG. 4 is a flowchart of an exemplary method for personalizing an electronic device, in accordance with an embodiment of the present invention. Referring to FIG. 4, there is shown steps 400 to 408. In step 400, a user of the electronic device 102, which may be a mobile device that may be purchased by a user, for example, may initiate activation of the electronic device 102. User initiated activation may be via, for example, a menu selection. The electronic device 102 may be provided with a list of authorized servers that may be allowed to interact with the electronic device 102 for activation. This information may be pre-provisioned in the electronic device 102 or provided in a subscriber identity module (SIM). The connectivity parameters in the SIM may be set for one-time usage for activation. This may be tracked, for example, by the DM client 126 and/or the DM server 134. The electronic device 102 may provide, for example, as part of activation, information to the servers 132 . . . 138 that may identify the device. The information may be, for example, an electronic serial number, a phone number, a media access control (MAC) address, and/or a stock keeping unit (SKU) number of the WiMax electronic device

Once activated, the user may access the self-care web-site 130 to reconfigure the electronic device 102. Various embodiments of the present invention may allow a user to access the self-care web-site 130 for activation. Accordingly, the electronic device 102 may be pre-provisioned for accessing the self-care web-site 130, or the provisioning may be available via a SIM.

In step 402, one or more of the servers 132 . . . 138 may determine a service plan associated with the electronic device 102. In step 404, one or more of the servers 132 . . . 138 may determine what provisioning is needed for the service plan associated with the electronic device 102. The servers 132 . . . 138 may then provision the electronic device 102 with the information needed. In step 406, one or more of the servers 132 . . . 138 may download applications via a WiMax network to enable the electronic device 102 to function as subscribed by the user. The application download may occur after further provisioning of the electronic device 102 as needed.

For example, the electronic device 102 may enter a WiMax network after downlink channel synchronization, initial ranging, capabilities negotiation, authentication message exchange, registration and IP connectivity stages. Accordingly, if the WiMax provisioning is not in place at the time of activation, the provisioning for WiMax network communication may be carried out via another wireless network, such as, for example, a WiFi network or a cellular network that may already be provisioned. The WiMax network may then be used for downloading applications and for further managing the electronic device 102. The applications to be downloaded may be specified, for example, by one of a plurality of service plans, where each service plan may be mapped to various applications and features.

However, prior to installation of the applications, the electronic device 102 and/or the servers 132 . . . 138 may need to verify that the drivers for the applications are available and other third party software used with the application is available. The verification may also involve version checks to ensure that a latest version of the application and/or tools are on the electronic device 102.

In step 408, the various applications that a user may have subscribed to may be enabled. Accordingly, the user may be able to use the electronic device 102 as desired. In this manner, the electronic devices may be loaded with a minimal feature set, and each electronic device may be managed and personalized for that user's subscribed applications. The management and personalization may be carried out via a broadband network that can access an electronic device in a wide area, such as, for example, the WiMax network.

Event logs may be generated as part of activation. Accordingly, a log may be kept of various steps taken in the activation and whether various steps of the activation process was successful or not.

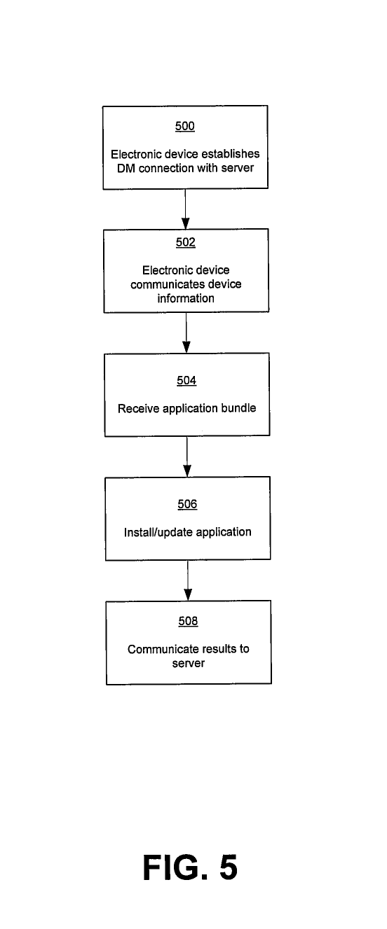

FIG. 5 is a flowchart of an exemplary method for device side support for activation, in accordance with an embodiment of the present invention. Referring to FIG. 5, there is shown steps 500 to 508. In step 500, the electronic device 102 may establish a DM connection with a server. For example, the DM client 126 may communicate with the DM server 134. In step 502, the electronic device 102 may communicate device information to the servers 132 . . . 138. The device information may comprise, for example, an electronic serial number (ESN), a phone number, a MAC address, and/or SKU number of the WiMax electronic device.

In step 504, the servers 132 . . . 138 may receive the device information from the electronic device 102 and determine the service class associated with the electronic device 102. Accordingly, the servers 132 . . . 138 may be able to determine which applications and provisioning data may need to be downloaded to the electronic device 102. In step 506, the electronic device 102 may use, for example, the update agent 114 to install the received application bundle from the servers 132 . . . 138. If the application is being updated, the received application bundle may be used to update the resident application. In step 508, the electronic device 102 may communicate the status of the application installation to the servers 132 . . . 138. If the application installation was a success, the application may be used by the electronic device 102. However, if the application installation was not successful, various error routines may be executed. The error routines may be design dependent. For example, the application may be downloaded again and/or reinstalled.

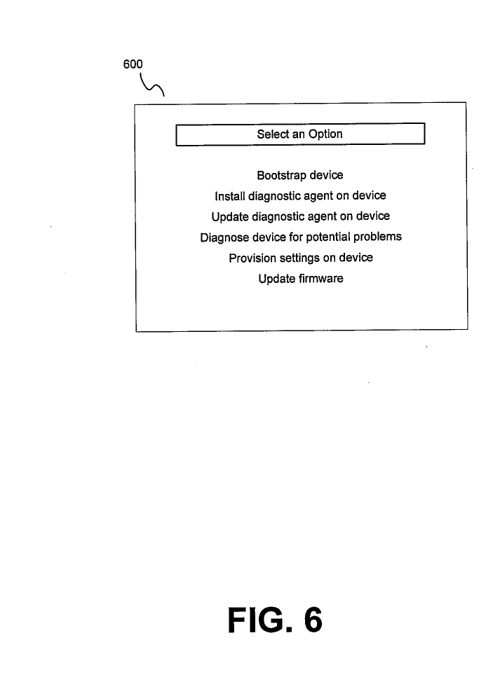

FIG. 6 is an exemplary menu for self-care by a user, in accordance with an embodiment of the present invention. Referring to FIG. 6, there is shown a menu 600 with a plurality of exemplary menu choices that may be displayed, for example, on the electronic device 102. The choices may comprise, for example, “Bootstrap device,” “Install diagnostic agent on device,” “Update diagnostic agent on device,” “Diagnose device for potential problems,” “Provision settings on device,” and “Update firmware.”

A user may select “Bootstrap device” to allow a server to start, for example, the process of activating the electronic device 102. The user may select the “Install diagnostic agent on device” to install the latest version of the diagnostic agent 110 in the electronic device 102. In a similar manner, the user may select “Update diagnostic agent on device” to update the diagnostic agent 110 to the latest version. The user may select “Diagnose device for potential problems” to run diagnostics on the electronic device 102.

The user may select “Provision settings on device” to provision the electronic device 102 for all services associate with the user's service plan. Selecting this option may also allow the electronic device 102 to auto-provision the electronic device 102 as the user selects the specific services. This may be, for example, when a user modifies or reconfigures the electronic device 102 using the self-care website 130. “Update firmware” may allow a user to update all applications, or selected applications, to the latest versions.

Although a system and method according to the present invention has been described in connection with the preferred embodiment, it is not intended to be limited to the specific form set forth herein, but on the contrary, it is intended to cover such alternative, modifications, and equivalents, as can be reasonably included within the scope of the present invention as defined by this disclosure and appended diagrams.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for interfacing to an electronic device, the method comprising: managing, via a wireless network compatible with one of the Institute of Electrical and Electronics Engineers, Inc. (IEEE) 802.16 family of standards, functionality of the electronic device, wherein said functionality comprises one or more of: activation, diagnostics, subscription to services, and quality of service options.

2. The method according to claim 1, comprising provisioning the electronic device as part of said activation to allow use of services listed in a subscriber service plan that corresponds to the electronic device, wherein prior to activation the electronic device is minimally provisioned to allow initiating said activation.

3. The method according to claim 2, comprising downloading applications needed for said services listed in said subscriber service plan.

4. The method according to claim 1, wherein said subscription to services functionality allows a user of the electronic device to change said services listed in said subscriber service plan.

5. The method according to claim 1, wherein said subscription to services functionality comprises services that allow a user to access a wireless network other than said IEEE 802.16 compatible network.

6. The method according to claim 1, comprising executing a diagnostics test on the electronic device by selecting said diagnostics functionality.

7. The method according to claim 6, comprising communicating diagnostic data generated by said diagnostics test, to one or more servers.

8. A machine-readable storage having stored thereon, a computer program having at least one code section for interfacing to an electronic device, the at least one code section being executable by a machine for causing the machine to perform steps comprising: managing, via a wireless network compatible with one of the Institute of Electrical and Electronics Engineers, Inc. (IEEE) 802.16 family of standards, functionality of the electronic device, wherein said functionality comprises one or more of: activation, diagnostics, subscription to services, and quality of service options.

9. The machine-readable storage according to claim 8, wherein the at least one code section comprises code for provisioning the electronic device as part of said activation to allow use of services listed in a subscriber service plan that corresponds to the electronic device, wherein prior to activation the electronic device is minimally provisioned to allow initiating said activation.

10. The machine-readable storage according to claim 9, wherein the at least one code section comprises code for downloading applications needed for said services listed in said subscriber service plan.

11. The machine-readable storage according to claim 8, wherein said subscription to services functionality allows a user of the electronic device to change said services listed in said subscriber service plan.

12. The machine-readable storage according to claim 8, wherein said subscription to services functionality comprises services that allow a user to access wireless networks other than said WiMax network.

13. The machine-readable storage according to claim 8, wherein the at least one code section comprises code for executing a diagnostics test on the electronic device by selecting said diagnostics functionality.

14. The machine-readable storage according to claim 13, wherein the at least one code section comprises code for communicating diagnostic data generated by said diagnostics test, to one or more servers.

15. A system for interfacing to an electronic device, the system comprising: one or more servers that manage, via a wireless network compatible with one of the Institute of Electrical and Electronics Engineers, Inc. (IEEE) 802.16 family of standards, functionality of the electronic device, wherein said functionality comprises one or more of: activation, diagnostics, subscription to services, and quality of service options.

16. The system according to claim 15, wherein said one or more servers enable provisioning of the electronic device as part of said activation to allow use of services listed in a subscriber service plan that corresponds to the electronic device, wherein prior to activation the electronic device is minimally provisioned to allow initiating said activation.

17. The system according to claim 16, wherein said one or more servers enable downloading of applications needed for said services listed in said subscriber service plan.

18. The system according to claim 15, wherein said subscription to services functionality allows a user of the electronic device to change said services listed in said subscriber service plan.

19. The system according to claim 15, wherein said subscription to services functionality comprises services that allow a user to access wireless networks other than said IEEE 802.16 compatible network.

20. The system according to claim 15, comprising executing a diagnostics test on the electronic device by selecting said diagnostics functionality.
